(19) United States
(12) Patent Application Publication
(10) Pub. No.: US 2023/0188665 A1
(43) Pub. Date: Jun. 15, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Tsutomu SHIMAMOTO, Kanagawa (JP)

(73) Assignee: FUJIFILM Business Innovation Corp., Tokyo (JP)

(21) Appl. No.: 17/749,130

(22) Filed: May 19, 2022

(30) Foreign Application Priority Data
Dec. 13, 2021 (JP) 2021-201817

(51) Int. Cl. H04N 1/44

(52) U.S. Cl. CPC H04N 1/4433; H04N 1/00514

(57) ABSTRACT

An information processing apparatus includes a processor configured to: receive an exchange between a first authority and a second authority among plural authorities that are distributed and managed by plural users and are provided for respectively changing plural settings, the first authority being assigned to a first user and provided for changing a setting to be changed, and the second authority being assigned to a second user; and exchange the second authority for the first authority.

### CROSS-REFERENCE TO RELATED APPLICATIONS

This application is based on and claims priority under 35 USC 119 from Japanese Patent Application No. 2021-201817 filed Dec. 13, 2021.

### BACKGROUND

### (i) Technical Field

The present invention relates to an information processing apparatus, a non-transitory computer readable medium storing an information processing program, and an information processing method.

### (ii) Related Art

JP2009-027237A discloses a technique of enabling a temporary use of an image forming function by an unregistered user to be permitted even in a case where an administrator is absent, without largely deteriorating security.

### SUMMARY

In the related art, there is known a method of managing a plurality of settings of an image forming apparatus by a plurality of users in a manner that an authority of an administrator who manages the image forming apparatus is distributed and the distributed authorities are assigned to the plurality of users.

However, in a case where a plurality of settings of an image forming apparatus is managed by a plurality of users with distributed authorities, and a response of a user to which the authority for changing the setting to be changed is assigned is not possible due to the absence and the like of this user, it is not possible to immediately change this setting. At this time, it is assumed that the authority for changing the setting to be changed is assigned to another user. However, in a case where the authority is concentrated on one user, it may not be possible to maintain a management method of avoiding a damage to the entirety of a system in a case where a fraudulent act is performed on the image forming apparatus.

Aspects of non-limiting embodiments of the present disclosure relate to an information processing apparatus, a non-transitory computer readable medium storing an information processing program, and an information processing method for, in a case where a plurality of authorities for respectively changing a plurality of settings are distributed and managed by a plurality of users, and a response of a user to which an authority for changing a setting to be changed is assigned is not possible, enabling another user to response without concentrating the distributed authorities on one user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus includes a processor configured to: receive an exchange between a first authority and a second authority among a plurality of authorities that are distributed and managed by a plurality of users and are provided for respectively changing a plurality of settings, the first authority being assigned to a first user and provided for changing a setting to be changed, and the second authority being assigned to a second user; and exchange the second authority for the first authority.

### BRIEF DESCRIPTION OF THE DRAWINGS

Exemplary embodiment(s) of the present invention will be described in detail based on the following figures, wherein:

FIG. 1 is a schematic diagram illustrating a configuration of an information processing system;

FIG. 2 is a block diagram illustrating a hardware configuration of an image forming apparatus;

FIG. 3 is a block diagram illustrating a hardware configuration of a user terminal;

FIG. 4 is a flowchart illustrating a flow of an exchange process by the image forming apparatus;

FIG. 5 is a first display example displayed on a display unit of the image forming apparatus;

FIG. 6 is a second display example displayed on the display unit of the image forming apparatus;

FIG. 7 is an explanatory diagram illustrating a list of authorities assigned to a plurality of users, before an exchange; and

FIG. 8 is an explanatory diagram illustrating a list of the authorities assigned to the plurality of users, after the exchange.

### DETAILED DESCRIPTION

Hereinafter, an information processing system 10 according to an exemplary embodiment will be described.

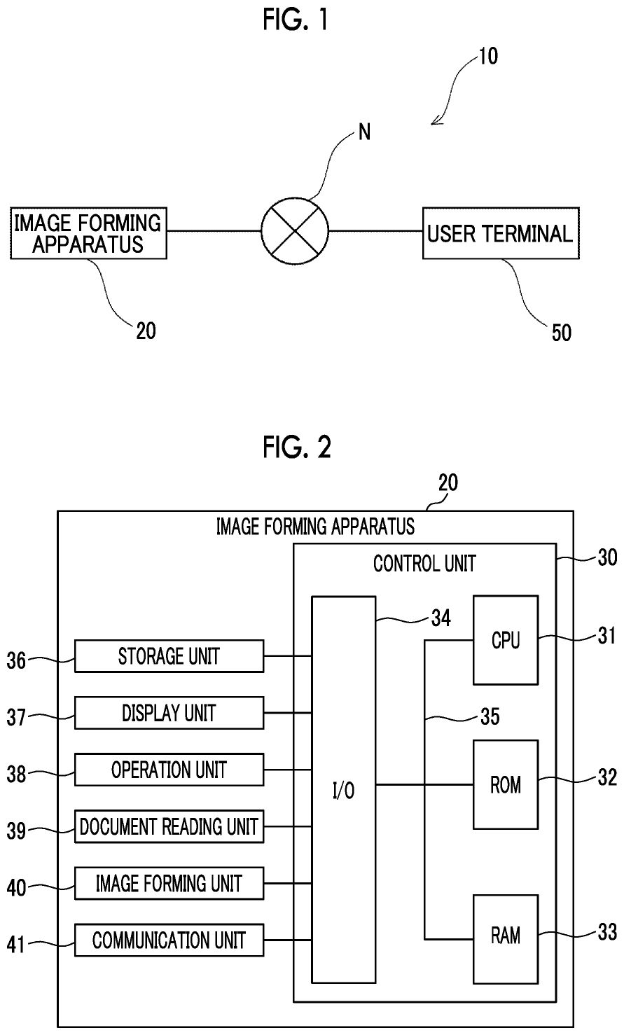

FIG. 1 is a schematic diagram illustrating a configuration of the information processing system 10.

As illustrated in FIG. 1, the information processing system 10 includes an image forming apparatus 20 and a user terminal 50. The image forming apparatus 20 and the user terminal 50 are connected to each other via a network N to be communicable with each other. As an example, the Internet, a local area network (LAN), and a wide area network (WAN) are applied as the network N.

The image forming apparatus 20 is provided with a plurality of authorities for respectively changing a plurality of settings such as copy settings and network settings. In the present exemplary embodiment, the plurality of authorities are distributed and managed by a plurality of users in order to avoid an occurrence of a situation in which a damage in a case where a fraudulent act is performed on the image forming apparatus 20 spreads to the entirety of the system by the authority concentrating on one user. As an example, in the present exemplary embodiment, there are three users being a user A, a user B, and a user C, as the plurality of users. The number of the plurality of users is not limited to three, and may be more or less than three.

The user terminal 50 is a terminal owned by each of a plurality of users who manage the image forming apparatus 20. As an example, a general-purpose computer device such as a server computer or a personal computer (PC), or a portable terminal such as a smartphone or a tablet terminal is applied as the user terminal 50. In the present exemplary embodiment, it is assumed that the user terminal 50 is a smartphone as an example.

FIG. 2 is a block diagram illustrating a hardware configuration of the image forming apparatus 20 that is an example of an information processing apparatus.

As illustrated in FIG. 2, the image forming apparatus 20 includes a control unit 30 that controls the operation of the image forming apparatus 20. In the control unit 30, a central processing unit (CPU) 31, a read only memory (ROM) 32, a random access memory (RAM) 33, and an input/output interface (I/O) 34 are connected to each other via a bus 35 to be communicable with each other.

The CPU 31 is a central arithmetic processing unit that executes various programs and controls the units. That is, the CPU 31 reads the program from the ROM 32 or a storage unit 36 described later, and executes the program using the RAM 33 as a work area. The CPU 31 controls the above components and executes various arithmetic processes, in accordance with the programs recorded in the ROM 32 or the storage unit 36. In the present exemplary embodiment, at least an information processing program for executing an exchange process described later is stored in the ROM 32 or the storage unit 36. The information processing program may be installed on the image forming apparatus 20 in advance, or may be appropriately installed on the image forming apparatus 20 by being stored in a non-volatile storage medium or distributed via the network N. As an example of the non-volatile storage medium, a CD-ROM, a magneto-optical disk, a hard disk drive (HDD), a DVD-ROM, a flash memory, a memory card, and the like are assumed. The CPU 31 is an example of a “processor”.

The ROM 32 stores various programs and various types of data. The RAM 33 temporarily stores the program or the data as a work area.

The storage unit 36, a display unit 37, an operation unit 38, a document scanning unit 39, an image forming unit 40, and a communication unit 41 are connected to the I/O 34. Each of the above units may communicate with the CPU 31 via the I/O 34.

The storage unit 36 is configured by a storage device such as an HDD, a solid state drive (SSD), or a flash memory, and stores various programs and various types of data. The storage unit 36 stores a destination table in which at least a mail address of each of the plurality of users is registered.

For example, a liquid crystal display and an organic electroluminescence (EL) are used as the display unit 37. The display unit 37 may integrally include a touch panel.

Various operation keys such as a numeric keypad and a start key are provided in the operation unit 38.

The display unit 37 and the operation unit 38 receive various instructions from a user of the image forming apparatus 20. The various instructions include, for example, an instruction to start scanning of a document and an instruction to start copying of the document. The display unit 37 displays various types of information such as the result of a process executed in accordance with the instruction received from the user and the notification in response to the process.

The document scanning unit 39 takes documents placed on a paper feed tray of an automatic document feeder (not illustrated) provided on the upper portion of the image forming apparatus 20 one by one, and optically scans the taken document to obtain image information. Alternatively, the document scanning unit 39 optically scans a document placed on a document stand such as platen glass to obtain image information.

The image forming unit 40 forms, on a recording medium such as paper, an image based on image information obtained by scanning of the document scanning unit 39 or image information obtained from an external PC or the like connected via the network N.

The communication unit 41 is an interface for communicating with other devices. For the communication, for example, the standard of a wired communication such as Ethernet (registered trademark) or FDDI, or the standard of a wireless communication such as 4G, 5G, or Wi-Fi (registered trademark) is used.

In a case of executing the above information processing program, the image forming apparatus 20 executes the process based on the information processing program by using the above hardware resources.

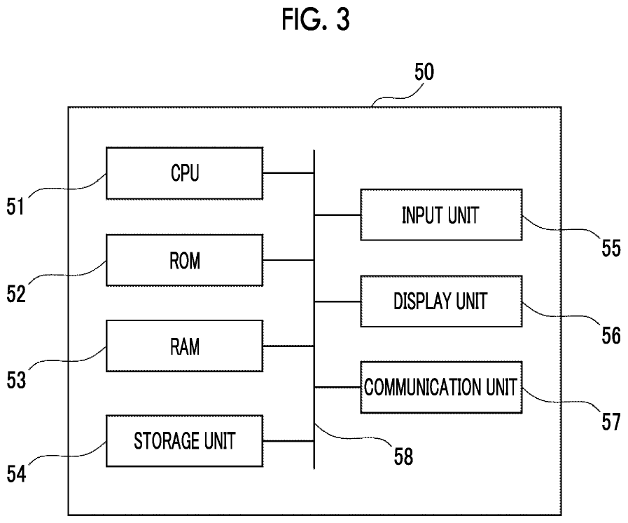

FIG. 3 is a block diagram illustrating a hardware configuration of the user terminal 50.

As illustrated in FIG. 3, the user terminal 50 includes a CPU 51, a ROM 52, a RAM 53, a storage unit 54, an input unit 55, a display unit 56, and a communication unit 57. The components are connected to each other via a bus 58 to be communicable with each other.

The CPU 51 is a central arithmetic processing unit that executes various programs and controls the units. That is, the CPU 51 reads the program from the ROM 52 or the storage unit 54, and executes the program using the RAM 53 as a work area. The CPU 51 controls the above components and executes various arithmetic processes, in accordance with the programs stored in the ROM 52 or the storage unit 54.

The ROM 52 stores various programs and various types of data. The RAM 53 temporarily stores the program or the data as a work area.

The storage unit 54 is configured by a storage device such as an HDD, an SSD, or a flash memory, and stores various programs including an operating system and various types of data.

The input unit 55 includes various buttons, a microphone, a camera, and the like as an example, and is used for performing various inputs.

The display unit 56 is, for example, a liquid crystal display and displays various types of information. The display unit 56 adopts a touch panel type and also functions as the input unit 55.

The communication unit 57 is an interface for communicating with other devices. For the communication, for example, the standard of a wired communication such as Ethernet (registered trademark) or FDDI, or the standard of a wireless communication such as 4G, 5G, or Wi-Fi (registered trademark) is used.

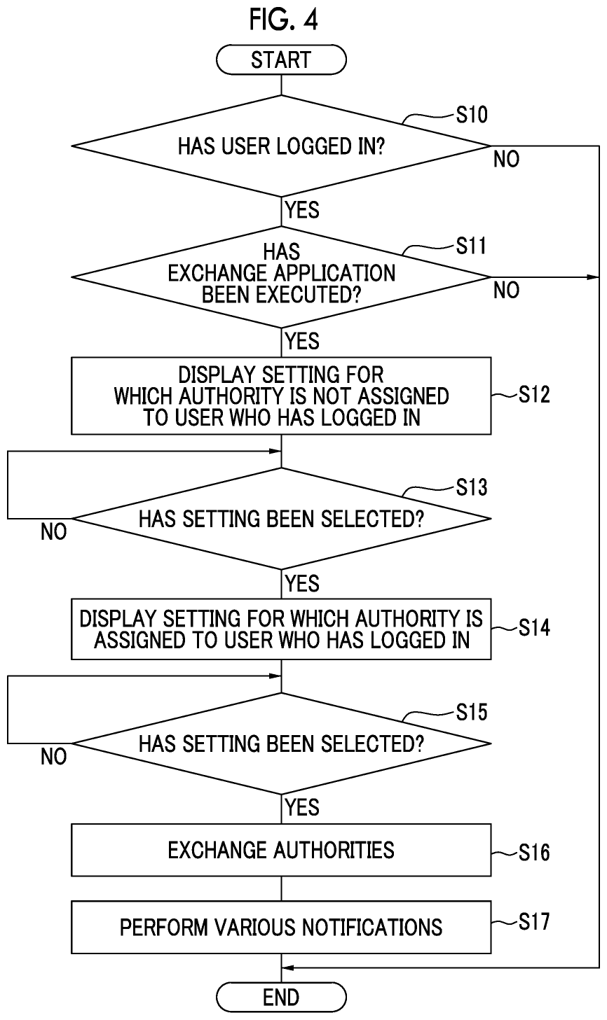

FIG. 4 is a flowchart illustrating a flow of an exchange process in which the image forming apparatus 20 exchanges the authority assigned to each of the plurality of users. The CPU 31 reads the information processing program from the ROM 32 or the storage unit 36, and loads and executes the information processing program on the RAM 33 to execute the exchange process.

In Step S10 illustrated in FIG. 4, the CPU 31 determines whether or not any one of the plurality of users has logged in to the image forming apparatus 20. In a case where the CPU 31 determines that the user has logged in (Step S10: YES), the CPU 31 proceeds to Step S11. On the other hand, in a case where the CPU 31 determines that the user has not logged in (Step S10: NO), the CPU 31 ends the exchange process.

In Step S11, the CPU 31 determines whether or not an application for exchanging the authority (referred to as an “exchange application” below) has been executed. In a case where the CPU 31 determines that the exchange application has been executed (Step S11: YES), the CPU 31 proceeds to Step S12. On the other hand, in a case where the CPU 31 determines that the exchange application has not been executed (Step S11: NO), the CPU 31 ends the exchange process.

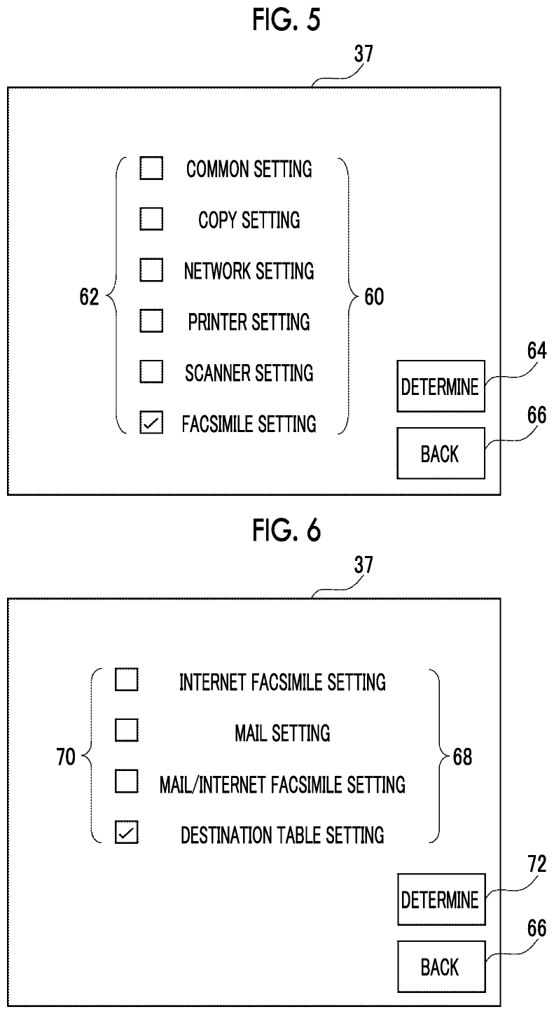

In Step S12, the CPU 31 displays, on the display unit 37, the setting for which the authority is not assigned to the user who has logged in in Step S10. Then, the process proceeds to Step S13. As an example, in a case where the user who has logged in in Step S10 is the user B, the CPU 31 displays a display example illustrated in FIG. 5 on the display unit 37 in Step S12.

FIG. 5 is a first display example displayed on the display unit 37 of the image forming apparatus 20. In the display example illustrated in FIG. 5, setting information 60, a check box 62, a determine button 64, and a back button 66 are displayed.

The setting information 60 indicates a setting for which an authority is not assigned to the user who has logged in to the image forming apparatus 20 in Step S10, here, the user B. In FIG. 5, six settings of “common setting”, “copy setting”, “network setting”, “printer setting”, “scanner setting”, and “facsimile setting” are displayed as the setting information 60. Such settings are not limited to the above types, and other types may be provided.

The check box 62 enables the user B to select a setting to be exchanged, from the six settings displayed as the setting information 60. The display example illustrated in FIG. 5 shows, as an example, a state after a check mark is added to the check box 62 on the left side of “facsimile setting” from the six settings displayed as the setting information 60. That is, the display example illustrated in FIG. 5 shows the state after the user B selects “facsimile setting” as the setting to be exchanged.

The determine button 64 is a button that is allowed to be operated after a check mark is added to any check box 62, and is provided for determining the setting corresponding to the check box 62 to which the check mark is added, as a target of the exchange.

The back button 66 is a button for displaying the home screen (not illustrated) of the image forming apparatus 20.

Returning to FIG. 4, in Step S13, the CPU 31 determines whether or not the setting to be exchanged has been selected. In a case where the CPU 31 determines that the setting has been selected (Step S13: YES), the CPU 31 proceeds to Step S14. On the other hand, in a case where the CPU 31 determines that the setting is not selected (Step S13: NO), the CPU 31 waits until the setting is selected.

In Step S14, the CPU 31 displays, on the display unit 37, a setting for which the authority is assigned to the user who has logged in in Step S10. Then, the process proceeds to Step S15. As an example, in a case where the user who has logged in in Step S10 is the user B, the CPU 31 displays a display example illustrated in FIG. 6 on the display unit 37 in Step S14.

FIG. 6 is a second display example displayed on the display unit 37 of the image forming apparatus 20. In the display example illustrated in FIG. 6, setting information 68, a check box 70, a determine button 72, and a back button 66 are displayed.

The setting information 68 indicates the setting for which the authority is assigned to the user who has logged in to the image forming apparatus 20 in Step S10, here, the user B. In FIG. 6, four settings of “Internet facsimile setting”, “mail setting”, “mail/internet facsimile setting”, and “destination table setting” are displayed as the setting information 68. Such settings are not limited to the above types, and other types may be provided.

The check box 70 enables the user B to select a setting to be exchanged, from the four settings displayed as the setting information 68. The display example illustrated in FIG. 6 shows, as an example, a state after a check mark is added to the check box 70 on the left side of “destination table setting” from the four settings displayed as the setting information 68. That is, the display example illustrated in FIG. 6 shows the state after the user B selects “destination table setting” as the setting to be exchanged.

The determine button 72 is a button that is allowed to be operated after a check mark is added to any check box 70, and is provided for determining the setting corresponding to the check box 70 to which the check mark is added, as a target of the exchange.

Returning to FIG. 4, in Step S15, the CPU 31 determines whether or not the setting to be exchanged has been selected. In a case where the CPU 31 determines that the setting has been selected (Step S15: YES), the CPU 31 proceeds to Step S16. On the other hand, in a case where the CPU 31 determines that the setting is not selected (Step S15: NO), the CPU 31 waits until the setting is selected.

In Step S16, the CPU 31 exchanges the authorities for changing the settings selected in Steps S13 and S15. Then, the CPU 31 proceeds to Step S17.

In Step S17, the CPU 31 performs various notifications to the plurality of users. Then, the CPU 31 ends the exchange process.

As an example, the CPU 31 notifies a partner user among the plurality of users of authority information regarding the exchanged authority and a cancellation number for canceling the exchange of the authority. The partner user refers to an exchange partner of an execution user who has executed the exchange of the authority. Specifically, the CPU 31 transmits an e-mail in which the authority information and the cancellation number have been described, to the e-mail address of the partner user. The partner user is an example of a “first user”, and the execution user is an example of a “second user”. In the present exemplary embodiment, as an example, the partner user is the “user A” and the execution user is the “user B”.

The authority information contains settings that are changeable based on the authority temporarily acquired by each of the execution user and the partner user. The cancellation number is, for example, a multi-digit number. The cancellation number is an example of “information for canceling the exchange of the authority”.

The CPU 31 notifies, of the authority information, a user other than the execution user and the partner user among the plurality of users, here, the user C. Specifically, the CPU 31 transmits an e-mail in which the authority information has been described, to the e-mail address of the user C. The user C is an example of a “user other than the first user and the second user”.

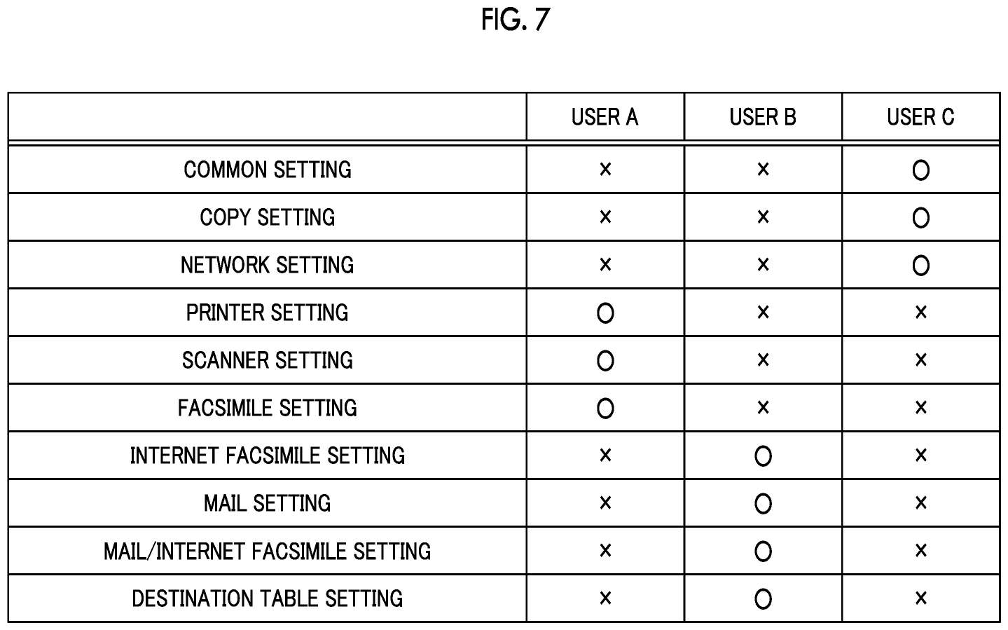

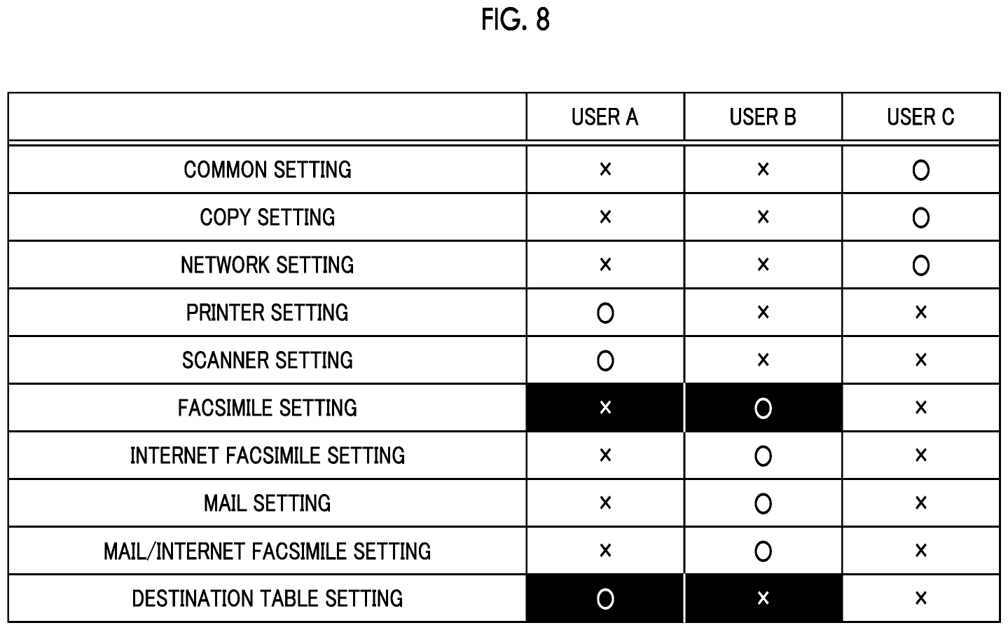

Next, the authorities before and after the exchange, which are assigned to the plurality of users will be described with reference to FIGS. 7 and 8.

FIG. 7 is an explanatory diagram illustrating a list of authorities assigned to a plurality of users, before the exchange. In the present exemplary embodiment, as an example, ten settings of “common setting”, “copy setting”, “network setting”, “printer setting”, “scanner setting”, “facsimile setting”, “Internet facsimile setting”, “mail setting”, “mail/Internet facsimile setting”, and “destination table setting” are provided as a plurality of settings of the image forming apparatus 20.

Here, in the present exemplary embodiment, ten authorities for changing the above respective ten settings are distributed and managed by the plurality of users A, B, and C. In the present exemplary embodiment, the above ten authorities are distributed so that the authorities of each of the user A, the user B, and the user C do not overlap. The present exemplary embodiment is not limited to this. In a case where a plurality of authorities are distributed and managed, some authorities may be shared by the plurality of users.

As illustrated in FIG. 7, before the exchange, authorities enabling changes of “printer setting”, “scanner setting”, and “facsimile setting” are assigned to the user A. Authorities enabling changes of “Internet facsimile setting”, “mail setting”, “mail/Internet facsimile setting”, and “destination table setting” are assigned to the user B. Authorities enabling changes of “common setting”, “copy setting”, and “network setting” are assigned to the user C. In FIGS. 7 and 8, the symbol “o” indicates that the authority is assigned, and the symbol “x” indicates that the authority is not assigned.

FIG. 8 is an explanatory diagram illustrating a list of the authorities assigned to the plurality of users, after the exchange. Here, as an example, it is assumed that “facsimile authority” for changing the facsimile setting, which is held by the user A and “destination table authority” for changing the destination table setting, which is held by the user B in FIG. 7 are exchanged. The facsimile authority is an example of a “first authority”, and the destination table authority is an example of a “second authority”.

As illustrated in FIG. 8, after the exchange, the authorities enabling the changes of “printer setting”, “scanner setting”, and “destination table setting” are assigned to the user A. The authorities enabling the changes of “Internet facsimile setting”, “mail setting”, “mail/Internet facsimile setting”, and “facsimile setting” are assigned to the user B. The authorities enabling the changes of “common setting”, “copy setting”, and “network setting” are assigned to the user C. In FIG. 8, the cells having contents that have been changed from FIG. 7 are shown in black.

Here, in the present exemplary embodiment, cases as follows are assumed as the situation in which the exchange process illustrated in FIG. 4 is executed. As an example, the situation is a case where a plurality of users receive a change request of the setting from a general user who does not hold the authority for changing the setting of the image forming apparatus 20, and the response of the user to which the authority for changing the setting corresponding to the change request is assigned among the plurality of users is not possible due to the absence or the like of this user.

In the above situation, in the present exemplary embodiment, as an example, the CPU 31 receives the exchange between a facsimile authority (which is assigned to the user A as the partner user and is provided for changing the facsimile setting to be changed) and a destination table authority assigned to the user B as the execution user among a plurality of authorities for respectively changing the plurality of settings in the image forming apparatus 20. Then, the CPU 31 exchanges the destination table authority for the facsimile authority. In a case where the CPU 31 performs the exchange, the CPU 31 assigns the destination table authority to the user A and assigns the facsimile authority to the user B, as illustrated in FIG. 8. Thus, according to the present exemplary embodiment, in a case where a plurality of authorities for respectively changing a plurality of settings are distributed and managed by a plurality of users, and a response of a user to which an authority for changing a setting to be changed is assigned is not possible, it is possible to enable another user to make a response without concentrating the distributed authorities on one user.

Further, in the present exemplary embodiment, the CPU 31 notifies the user A being the partner user, of the authority information and the cancellation number. Thus, according to the present exemplary embodiment, it is possible to cause the partner user to recognize that the exchange of the authority has been performed and that the cancellation of the exchange of the authority is possible.

In the present exemplary embodiment, the CPU 31 notifies the user C being a user other than the execution user and the partner user, of the authority information. Thus, according to the present exemplary embodiment, it is possible to cause all the plurality of users to recognize that the exchange of the authority has been performed.

Here, in the present exemplary embodiment, in a case where a predetermined cancellation condition is established, the CPU 31 cancels the exchange between the facsimile authority and the destination table authority, which has been performed as described above. Thus, according to the present exemplary embodiment, it is possible to bring the authorities of the partner user and the execution user back to the original state.

As an example, in the present exemplary embodiment, the case where the predetermined cancellation condition is established includes a case where the cancellation of the exchange by the user A being the partner user using the cancellation number is received, and a case where a predetermined time has been elapsed from the exchange between the facsimile authority and the destination table authority. The cancellation of the exchange by using the cancellation number is performed, as an example, in a manner that the user A has logged in to the image forming apparatus 20 to execute the exchange application, and inputs the cancellation number on a predetermined screen of the exchange application. Thus, according to the present exemplary embodiment, it is possible to bring the authorities of the partner user and the execution user back to the original state by the intention of the partner user. Further, according to the present exemplary embodiment, it is possible to bring the authorities of the partner user and the execution user back to the original state without receiving the operation of the user. The above “predetermined time” may be an hour unit such as one hour or three hours, or a daily unit such as one day or three days.

Further, in the present exemplary embodiment, in a case where the exchange between the facsimile authority and the destination table authority has been canceled, the CPU 31 notifies a plurality of users of a cancellation mail indicating that the exchange between the facsimile authority and the destination table authority has been canceled. Thus, according to the present exemplary embodiment, it is possible to cause all the plurality of users to recognize that the exchange between the facsimile authority and the destination table authority has been canceled. The cancellation mail is an example of “information indicating that the exchange has been canceled”.

### Others

In the above exemplary embodiment, the example of the “information for canceling the exchange of the authority” is assumed to be the cancellation number being a multi-digit number, but the example is not limited to this. As another example, a cancellation code configured by a multi-digit alphabet, a multi-digit alphanumerical, or a combination of multi-digit alphabets, numbers, and symbols may be used as an example of the “information for canceling the exchange of authority”.

In the above exemplary embodiment, the situation where the exchange process is performed is a case where the plurality of users receive the change request of the setting from a general user, and the response of the user to which the authority for changing the setting corresponding to the change request is assigned among the plurality of users is not possible. At this time, in the case where the response of the user to which the authority is assigned is not possible, one of the plurality of users may manually make a determination, or the user terminal 50 may perform an automatic determination without the user intervention.

In the above exemplary embodiment, by displaying the display example illustrated in FIG. 6 on the display unit 37, the execution user receives the selection of the setting to be exchanged. At this time, the execution user selects the setting that is not currently used, but the execution user may manually make such a selection, or the image forming apparatus 20 may automatically perform such a selection without the user intervention.

In the above exemplary embodiment, it is assumed that the exchanged authority is brought back to the original state by establishing the predetermined cancellation condition, but the present exemplary embodiment is not limited to this. The state after the exchange may be maintained and the authority may not be brought back to the original state.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
receive an exchange between a first authority and a second authority among a plurality of authorities that are distributed and managed by a plurality of users and are provided for respectively changing a plurality of settings, the first authority being assigned to a first user and provided for changing a setting to be changed, and the second authority being assigned to a second user; and
exchange the second authority for the first authority.

2. The information processing apparatus according to claim 1, wherein the processor is configured to:
notify the first user of authority information regarding the exchanged authority and information for canceling the exchange of the authority.

3. The information processing apparatus according to claim 2, wherein the processor is configured to:
notify a user other than the first user and the second user among the plurality of users, of the authority information.

4. The information processing apparatus according to claim 1, wherein the processor is configured to:
in a case where a predetermined cancellation condition is established, cancel the exchange between the first authority and the second authority.

5. The information processing apparatus according to claim 2, wherein the processor is configured to:
in a case where a predetermined cancellation condition is established, cancel the exchange between the first authority and the second authority.

6. The information processing apparatus according to claim 3, wherein the processor is configured to:
in a case where a predetermined cancellation condition is established, cancel the exchange between the first authority and the second authority.

7. The information processing apparatus according to claim 4,
wherein the case where the predetermined cancellation condition is established is a case where the cancellation of the exchange by the first user using information for canceling the exchange of the authority is received.

8. The information processing apparatus according to claim 5,
wherein the case where the predetermined cancellation condition is established is a case where the cancellation of the exchange by the first user using information for canceling the exchange of the authority is received.

9. The information processing apparatus according to claim 6,
wherein the case where the predetermined cancellation condition is established is a case where the cancellation of the exchange by the first user using information for canceling the exchange of the authority is received.

10. The information processing apparatus according to claim 4,
wherein the case where the predetermined cancellation condition is established is a case where a predetermined time has elapsed from the exchange between the first authority and the second authority.

11. The information processing apparatus according to claim 5,
wherein the case where the predetermined cancellation condition is established is a case where a predetermined time has elapsed from the exchange between the first authority and the second authority.

12. The information processing apparatus according to claim 6,
wherein the case where the predetermined cancellation condition is established is a case where a predetermined time has elapsed from the exchange between the first authority and the second authority.

13. The information processing apparatus according to claim 7,
wherein the case where the predetermined cancellation condition is established is a case where a predetermined time has elapsed from the exchange between the first authority and the second authority.

14. The information processing apparatus according to claim 8,
wherein the case where the predetermined cancellation condition is established is a case where a predetermined time has elapsed from the exchange between the first authority and the second authority.

15. The information processing apparatus according to claim 9,
wherein the case where the predetermined cancellation condition is established is a case where a predetermined time has elapsed from the exchange between the first authority and the second authority.

16. The information processing apparatus according to claim 4, wherein the processor is configured to:
in a case where the exchange between the first authority and the second authority has been canceled, notify the plurality of users of information indicating that the exchange between the first authority and the second authority has been canceled.

17. The information processing apparatus according to claim 5, wherein the processor is configured to:
in a case where the exchange between the first authority and the second authority has been canceled, notify the plurality of users of information indicating that the exchange between the first authority and the second authority has been canceled.

18. The information processing apparatus according to claim 6, wherein the processor is configured to:
in a case where the exchange between the first authority and the second authority has been canceled, notify the plurality of users of information indicating that the exchange between the first authority and the second authority has been canceled.

19. A non-transitory computer readable medium storing an information processing program causing a computer to execute a process comprising:
receiving an exchange between a first authority and a second authority among a plurality of authorities that are distributed and managed by a plurality of users and are provided for respectively changing a plurality of settings, the first authority being assigned to a first user and provided for changing a setting to be changed, and the second authority being assigned to a second user; and
exchanging the second authority for the first authority.

20. An information processing method comprising:
receiving an exchange between a first authority and a second authority among a plurality of authorities that are distributed and managed by a plurality of users and are provided for respectively changing a plurality of settings, the first authority being assigned to a first user and provided for changing a setting to be changed, and the second authority being assigned to a second user; and
exchanging the second authority for the first authority.
